(19) United States
(12) Patent Application Publication
(10) Pub. No.: US 2018/0011186 A1
(43) Pub. Date: Jan. 11, 2018

(54) RADAR ASSEMBLY

(71) Applicant: Reutech Radar Systems (Proprietary) Limited, Stellenbosch (ZA)

(72) Inventors: Stephanus Johannes Nortjé, Somerset West (ZA); Paulus Jacobus van der Merwe, Durbanville (ZA); Werner Steyn, Stellenbosch (ZA); Charl Wynand Baard, Somerset West (ZA)

(21) Appl. No.: 15/634,704

(22) Filed: Jun. 27, 2017

(30) Foreign Application Priority Data
Jul. 8, 2016 (ZA) 2016/04715

(51) Int. Cl. G01S 13/88; H01Q 1/38; H01Q 1/27; H01Q 9/28; H01Q 1/24

(52) U.S. Cl. CPC G01S 13/885; H01Q 9/28; H01Q 1/24; H01Q 1/273; H01Q 1/38

(57) ABSTRACT

A radar assembly includes a hollow drum and an antenna holding structure located inside the hollow drum so that the hollow drum can rotate around the antenna holding structure. An antenna is connected to the antenna holding structure and located inside the hollow drum so that the hollow drum can rotate around the antenna. The antenna holding structure is connected to a base frame and to which the hollow drum is connected via at least one axle so that the hollow drum can rotate around the antenna holding structure while the antenna holding structure and antenna remain stationary. A handle is connected to the base frame so that a user can direct the antenna towards a surface of interest which is to be radiated and can then roll the hollow drum over the surface while maintaining the antenna in a user selected orientation.

### CROSS-REFERENCE TO RELATED APPLICATION

The present application claims priority from South African Patent Application No. 2016/04715 filed on Jul. 8, 2016, the content of which is hereby incorporated by reference into this application.

### TECHNICAL FIELD OF THE INVENTION

The present application relates to a radar assembly, specifically for a ground penetrating radar system.

### BACKGROUND OF THE INVENTION

One application of such ground penetrating radar (GPR) is for underground use in mines, such as gold or platinum mines as a sub-surface profiler.

A GPR detects subterranean objects in ground or rock by radiating electromagnetic waves into the ground or rock medium by means of a transmitter driving an antenna. It then collects waves that are reflected back in the direction of the radar by underground objects by means of an antenna that provides an electrical signal for a receiver. The receiver amplifies, processes and samples the signal.

The sampled signal is processed digitally with a digital signal processor to detect, identify and classify reflecting objects.

In many GPRs separate transmit and receive antenna elements are used, but radars that use the same antenna for transmitting and receiving signals are also common.

To ensure efficient radiation into a ground or rock medium and to minimise above-ground radiation, it is required that the antenna elements are close to, or in contact with, the ground or rock. While horn antennas have been used for ground penetrating radars, the preferred antenna element is a “bow-tie” dipole antenna.

An arrangement that is often used in existing GPRs is to mount the antenna element on a thick rubber mat that is placed directly on the ground or rock surface. Such an antenna assembly may weigh several kilogrammes. The antenna assembly is then dragged along the surface to perform a linear scan of the site under investigation. The rubber mat serves the dual purpose of protecting the antenna elements while the relatively high dielectric constant of the rubber improves the radiation efficiency into the ground or rock.

However, there is an appreciable amount of friction between the antenna assembly and the ground or rock surface and it may require an appreciable effort to drag the antenna across the surface.

With separate transmit and receive antennas, the rubber mat will usually take on a square shape to accommodate both antennas, and consequently has a large footprint compared to the size of a radar with only one antenna element. The large footprint increases the spacing that can be achieved between the antennas and a rough surface, thus reducing radiation efficiency into the rock.

Especially in underground applications in deep mines it can be very difficult and exhausting for the operator to drag a heavy radar antenna across the roof of the mine while the operator has to move on his knees over a rocky surface because of the limited confines of the mine. The operator must exert considerable force to not only support the radar but also keep it in contact with the rock surface. The constant rubbing between the antenna assembly and the mine surface can also cause appreciable wear of the rubber surface, especially on uneven rock surfaces. In cases where post-processing is done on recorded data, the position of the antenna must also be known so that measurements can be taken at fixed distances. For this purpose a grid usually has to be marked out on the roof surface before a scan can be undertaken.

A second operator may be required to tell the first operator when to take measurements as he drags the antenna across the mine roof surface.

An alternative arrangement is to mount the antenna on a low wheeled trolley. Such an arrangement is not well suited to rough surfaces, as typically encountered in platinum and gold mines, nor for overhead use.

There is a clear need for a lightweight antenna arrangement suitable for scanning overhead uneven rock surfaces with minimal physical effort.

The present invention provides a radar assembly to address this.

### SUMMARY OF THE INVENTION

According to one example embodiment there is provided a radar assembly including:
a hollow drum;
an antenna holding structure located inside the hollow drum so that the hollow drum is able to rotate around the antenna holding structure;
an antenna connected to the antenna holding structure and located inside the hollow drum so that the hollow drum is able to rotate around the antenna;
a base frame to which the antenna holding structure is connected and to which the hollow drum is connected via at least one axle so that the hollow drum is able to rotate around the antenna holding structure while the antenna holding structure and antenna remain stationary; and
a handle connected to the base frame so that in use a user can direct the antenna towards a surface of interest which is to be radiated and can then roll the hollow drum over the surface whilst maintaining the antenna in a user selected orientation.

A matching section element for the antenna may also be connected to the antenna holding structure.

Preferably, a printed circuit board including radar electronics is also located inside the hollow drum so that the hollow drum is able to rotate around the printed circuit board.

In one example, the hollow drum is covered with rubber.

Preferably, the antenna holding structure is connected to the base frame by means of a suspension.

Switch controls for the radar are preferably mounted at or near a bottom end of the handle where they are conveniently located for a user to be able to switch the radar on and off.

### BRIEF DESCRIPTION OF THE DRAWINGS

FIG. 1 is a radar assembly according to the present invention;

FIG. 2 is an exploded view of an antenna assembly of FIG. 1;

FIG. 3 shows the complete antenna assembly;

FIG. 4 shows an exploded view of the radar assembly;

FIG. 5 shows a partial cut-away view of the radar assembly;

FIG. 6 shows the complete radar assembly;

FIG. 7 shows the radar assembly mounted on a base frame by means of two suspension frames; and

FIG. 8 shows a cross section through the antenna showing the basic parts.

### DESCRIPTION OF EMBODIMENTS

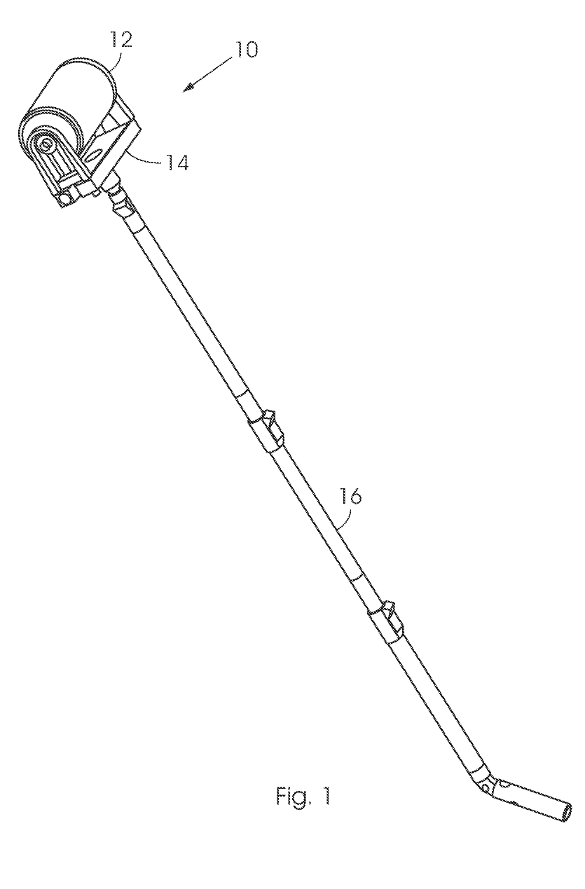

Referring to FIG. 1, a radar assembly 10 includes an antenna assembly portion 12 connected to a base frame 14.

A handle 16 is also connected to the base frame 14. It will be appreciated that the handle 16 is elongate to allow the antenna assembly portion 12 to be easily held up against an overhead surface and rolled over the surface as will be described in more detail below.

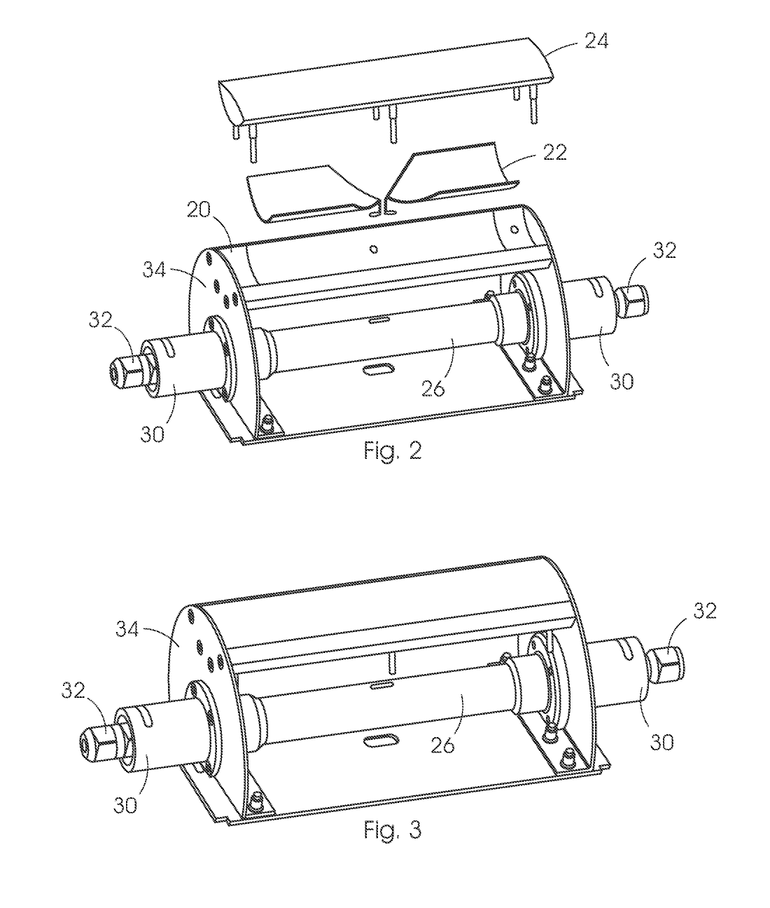

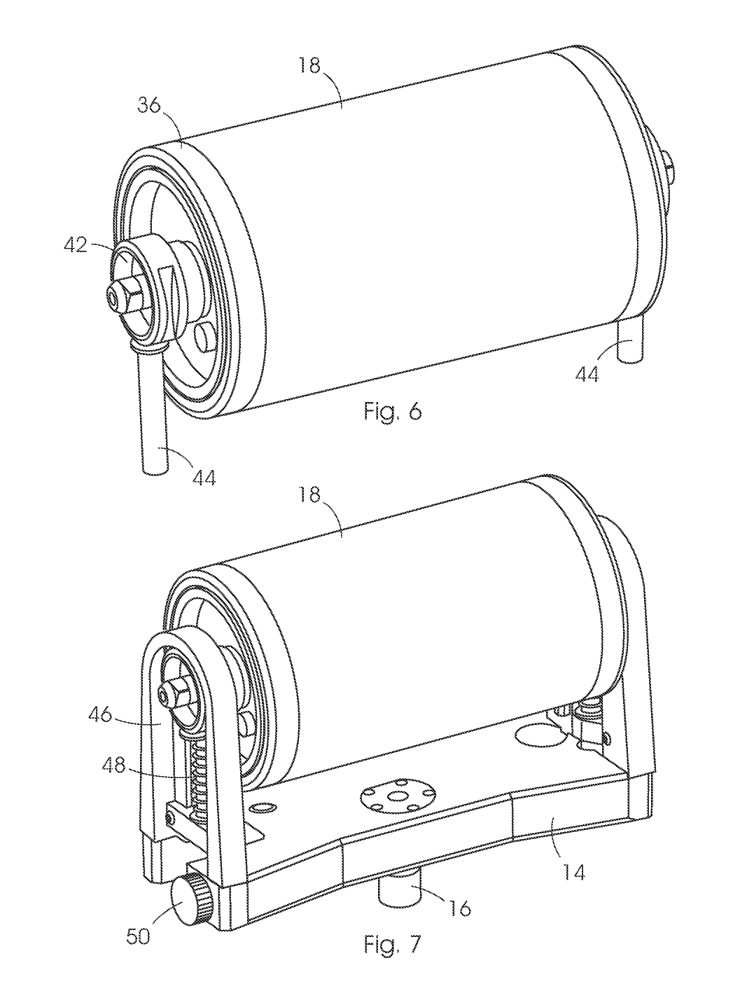

Referring now to FIG. 2-8, the antenna assembly portion 12 includes a hollow drum 18.

An antenna holding structure 20 is located inside the hollow drum 18 so that the hollow drum 18 is able to rotate around the antenna holding structure 20, as will be described in more detail below.

The rotatable drum 18 is covered with rubber on its outer surface.

As can best be seen in FIG. 2, in the illustrated embodiment, the antenna is a bowtie dipole antenna 22 which is mounted on the antenna holding structure 20 which is made from a plastic material in the form of a curved plastic surface. This forms the bottom element of the bow tie antenna.

A matching section element 24 of the bow-tie antenna is manufactured from a suitable material with a high dielectric constant, such as neoprene rubber. It has a mainly electromagnetic function and serves to improve the electrical coupling between the antenna 22 and the ground surface, so that radiation is directed into the ground or rock that is scanned.

A centre support 26 is made from a plastic material and serves as a structural member and also houses the axles for the rotating parts.

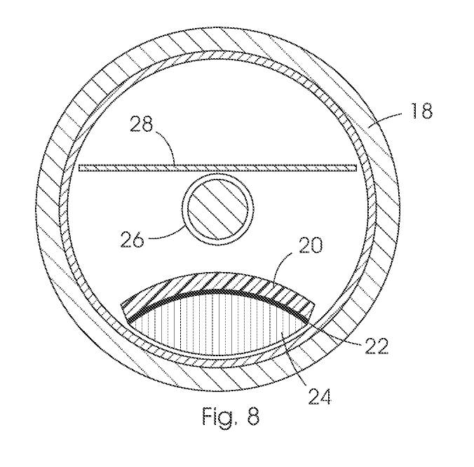

A printed circuit board (PCB) 28 (FIG. 8) is also contained within the hollow drum 18.

This PCB 28 houses the radar electronics. A conducting layer on the bottom of the PCB shields the radar electronics from the antenna radiation.

The radar electronics typically include a digital signal processing module, a Wi-Fi communications module and an optical counter that counts the revolutions of the hollow drum 18.

Referring again to FIG. 2, the figure shows the location of stub axles 30 that house cable glands 32 for the battery cable.

The stub axles 30 are firmly fixed to the centre support 26 by means of screws and also serve to keep bow-tie shield ends 34 in position.

The shield ends 34 support the PCB 28 and bow-tie antenna elements 20, 22 and 24 to realise a structurally strong assembly by means of polycarbonate screws.

FIG. 3 shows the complete antenna assembly.

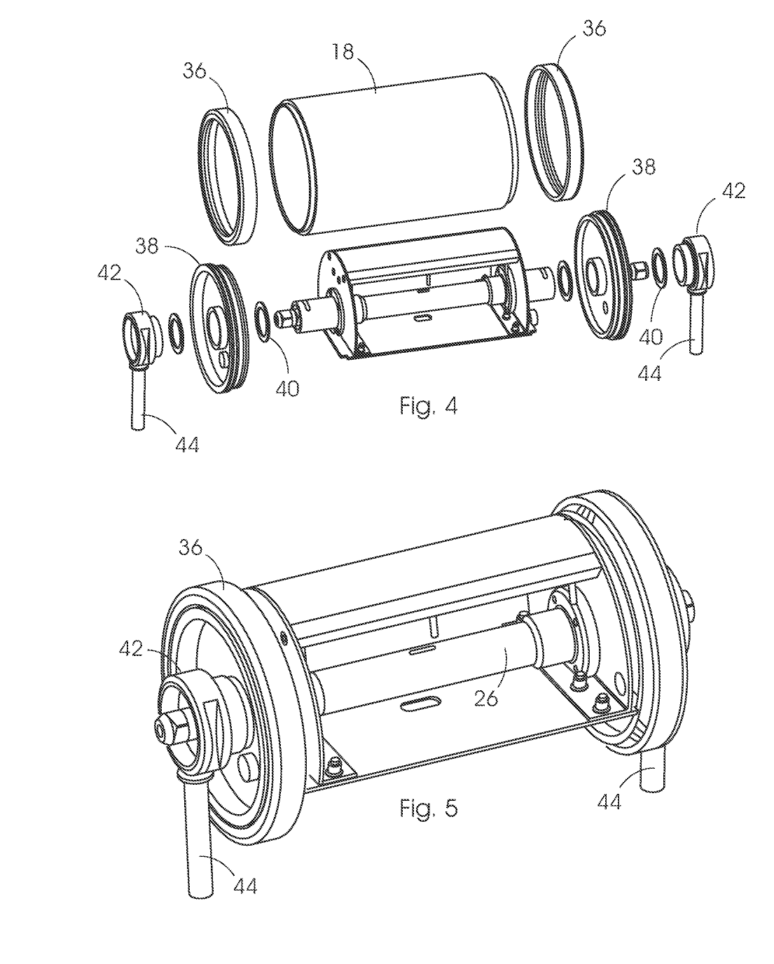

Referring now to FIGS. 4-6 which show the radar assembly including the antenna assembly.

The rotating hollow drum 18 is made of a suitable plastic material that is mechanically strong and transparent to electromagnetic waves, such as poly-acrylic plastic.

As mentioned above, the hollow drum 18 is covered with a rubber tyre made of a suitable material with the desired electrical and mechanical properties, such as neoprene rubber.

The hollow drum, tyre and drum edges are protected by two rim protectors 36 made from a suitable material such as neoprene rubber.

The rim protectors 36 mount onto two rotating hubs 38 that in turn rotate on the two stub axles 30, made from a suitable bearing material such as polyacetal.

The rotating hubs are kept in position by washers 40 and the axle bosses 42.

The axle bosses 42 are supported by spring guide pins 44.

FIG. 7 shows the radar assembly mounted on the base frame 14 by means of a suspension in the form of two suspension frames 46.

The suspension frames 46 support the radar assembly by means of suspension springs 48 that are kept in position by the spring guide pins 44 (See FIG. 4).

The suspension allows the roller to follow rough terrain by allowing relative movement between the radar assembly and the base frame.

The base frame 14 also houses a battery compartment, with a screw-on battery cover 50. The battery compartment is used for housing a battery to power the assembly when in use.

The base frame 14 also makes provision for housing cable connections and can be fixed to the handle as illustrated in FIG. 1.

Referring back to FIG. 1, the complete Ground Penetrating Radar system is shown.

The springe suspension allows the radar to traverse a rough surface while tracing a smooth curve with the handle 16. Switch controls for the radar are mounted at or near a bottom end of the handle 16 where they are conveniently located for the operator to be able to switch the radar on and off. It will be appreciated that in this example there will be wires connecting the switch controls to the printed circuit board 28 and that these wires will run inside the handle 16.

Thus it will be appreciated that the antenna elements are mounted inside one or more rubber-covered rollers that can be rolled over the surface to be scanned, thus eliminating friction and allowing the antenna to be drawn across a rough rock surface with minimal spacing between the antenna element and the rock surface.

Small dielectric matching elements between the antenna elements and the roller circumference are used to further improve the effective radiation of radio waves into the ground or rock.

In the embodiment described above, a single antenna is used that is mounted inside a single roller. The same principles apply for the case where dual antenna elements are mounted in a pair of rollers.

The main advantage of this arrangement is that friction and rubbing between the antenna element and the ground is eliminated completely. A small spacing between the antenna element and the rock surface can be maintained, enhancing the radiation efficiency into the ground or rock. The small spacing also helps to minimise above-ground radiation.

Finally, the operator has a much easier task to perform as friction has, for practical purposes, been eliminated and a light weight construction is possible. The rollers are also used to measure the distance travelled, thus providing accurate data on the position of the radar and eliminating the need for a second operator to keep track of position and to prompt the operator on when to take measurements.

1. A radar assembly including:
a hollow drum;
an antenna holding structure located inside the hollow drum so that the hollow drum is able to rotate around the antenna holding structure;
an antenna connected to the antenna holding structure and located inside the hollow drum so that the hollow drum is able to rotate around the antenna;
a base frame to which the antenna holding structure is connected and to which the hollow drum is connected via at least one axle so that the hollow drum is able to rotate around the antenna holding structure while the antenna holding structure and antenna remain stationary; and
a handle connected to the base frame so that in use a user can direct the antenna towards a surface of interest which is to be radiated and can then roll the hollow drum over the surface whilst maintaining the antenna in a user selected orientation.

2. A radar assembly according to claim 1 wherein a matching section element for the antenna is also connected to the antenna holding structure to improve the electrical coupling between the antenna and a surface so that radiation is directed into the surface that is scanned.

3. A radar assembly according to claim 1 further including a printed circuit board including radar electronics also located inside the hollow drum so that the hollow drum is able to rotate around the printed circuit board.

4. A radar assembly according to claim 3 wherein the printed circuit board includes at least one of a digital signal processing module, a communications module and an optical counter that counts the revolutions of the hollow drum.

5. A radar assembly according to claim 1 wherein the hollow drum is covered with rubber.

6. A radar assembly according to claim 1 wherein the antenna holding structure is connected to the base frame by means of a suspension spring.

7. A radar assembly according to claim 1 wherein switch controls for the radar are mounted at or near a bottom end of the handle where they are conveniently located for a user to be able to switch the radar on and off.

8. A radar assembly according to claim 1 wherein the antenna is a bowtie dipole antenna.

9. A radar assembly according to claim 1 wherein the antenna holding structure is made from a plastic material.

10. A radar assembly according to claim 1 wherein the hollow drum is made of a suitable plastic material that is mechanically strong and transparent to electromagnetic waves.

11. A radar assembly according to claim 1 wherein the base frame has a battery compartment therein for housing a battery to power the assembly when in use.
